(19) United States
(12) Patent Application Publication
(10) Pub. No.: US 2006/0203389 A1
(43) Pub. Date: Sep. 14, 2006

(54) Magnetic head with projections on flexure holding slider

(75) Inventor: Michiharu Motonishi, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/369,278

(22) Filed: Mar. 6, 2006

(30) Foreign Application Priority Data
Mar. 10, 2005 (JP) 2005-067252

(51) Int. Cl. G11B 5/60

(52) U.S. Cl. 360/234.6

(57) ABSTRACT

In a magnetic head adhesively fixing a slider having a thin film magnetic element on a slider adhesive tongue of a flexure made of metal material constituting a gimbal suspension through a plurality of spacer projections formed on the slider adhesive tongue, four spacer projections are provided on the slider adhesion tongue in a radial direction from a predetermined center position overlapping a center of an adhesive surface of the slider. The slider is adhered onto the spacer projections by adhesive resin applied therebetween.

### BACKGROUND OF THE INVENTION

1. Field of the Invention

The present invention relates to a magnetic head having a slider which is adhesively supported to a flexure of a head gimbal assembly.

2. Description of the Related Art

A HGA (head gimbal assembly) widely used in HDD is formed by adhesively fixing a slider having a thin film magnetic head element (MR element, GMR element) on one tip of a flexure which made of metal and is fixed on a front tip of a load beam. In a structure in which the slider is adhesively fixed on the surface of the flexure directly by adhesive resin, the thickness of the applied adhesive resin is not uniform, and the structure may introduce deformation and declination to the slider due to uneven shrinkage and temperature changes upon curing of the adhesive resin.

Therefore, a structure has been developing in which spacer projections and slits are provided on the surface of the flexure, the adhesive resin fills a region surrounded by the spacer projections and a region defined by the spacer projections and slits, so that the slider is adhesively fixed on the flexure (see JP-A-7-169224 (U.S. Pat. No. 6,801,398 B1), JP-A-9-282824 (U.S. Pat. No. 5,880,908), and JP-A-11-149625 (U.S. Pat. No. 6,078,472)). FIG. 7 is a perspective view showing a state before a slider is adhesively fixed on a front tip of a flexure according to the related art, and FIG. 8 is a plan view showing a flexure according to the related art. A flexure 121 has thereon a plurality of rod-shaped spacer projections 122a, 122b, and 122c supporting the vicinities of three sides of a rear surface of a slider 11, a circular spacer projection 122d supporting the center of the rear surface of the slider 111, and electrodes 133a to 133d formed on a FPC substrate. The slider 111 has a magnetic head element 113 meeting with a surface (ABS surface) 112 facing a magnetic recording medium, and electrodes 114a to 114d connected to the magnetic head element 113 on its trailing end surface. The electrodes 114a to 114d are connected to the electrodes 133a to 133d by ball bonding.

The slider 111 is adhered onto the spacer projections 122a to 122d and the flexure 121 at the rear surface of the slider opposite to the surface 112 facing the recording medium by adhesive resin 124 that is applied on the spacer projections 122a to 122d or filled in the region surrounded by the spacer projections 122a to 122c. An ultraviolet curing adhesive resin is used as the adhesive resin 124, the ultraviolet curing adhesive resin is cured by irradiating with ultraviolet rays thereon.

However, when the adhesive resin 124 is applied on a central region, as shown in FIG. 8, the adhesive resin 124 partially and unevenly spreads, which leads to variations in an applied area and irregular deformation. In addition, if the adhesive resin is thickly applied on the surface of the circular spacer projection 122d at the center, the slider 111 is separated from one of the spacer projections 122a to 122c other than the spacer projection 122d, which leads to declining and out of alignment of the slider 111.

While the ultraviolet curing adhesive resin 124 is being cured by irradiating ultraviolet rays, most of the ultraviolet rays entering from the side are blocked by the spacer projections 122a to 122c. For this reason, according to the related art, the UV holes 125a and 125b are formed in the flexure 121 so as to enlarge an area irradiated by the ultraviolet radiation. However, the ultraviolet radiation does not sufficiently irradiate the adhesive resin through the UV holes 125a and 125b, and the adhesive resin 124 that is separated from the holes are not sufficiently cured, which causes the flexure 121 to deform. If the UV holes 125a and 125b are formed in a larger size, for example, when a long slit is formed as described in JP-A-1995-169224, the strength of the flexure 121 grows weaker, which causes the flexure 121 to easily deform and even leads to leakage of the adhesive resin 124 from the slit. Moreover, the structure (JP-A-1997-282824 and JP-A-1999-149625), in which more spacer projections are provided by decreasing the size of each spacer projection, may introduce deformation due to uneven application and curing of the adhesive resin.

### SUMMARY OF THE INVENTION

The present invention has been made in view of the drawbacks inherent in the magnetic head according to the related art, and it is an object of the present invention to provide a magnetic head in which an adhesive resin adhering a slider of the magnetic head onto a flexure is evenly applied, the slider and the flexure are kept from deforming, and thereby easily adhering onto each other.

According to an aspect of the invention, in a magnetic head in which a slider having a thin film magnetic element is adhesively fixed on a flexure, made of metal material, constituting a gimbal suspension through a plurality of spacer projections provided on the flexure, the slider is adhered onto the flexure by adhesive resin which is applied between the slider and the spacer projections and spreads along the respective spacer projections.

According to the aspect of the invention, preferably, the spacer projections are provided in a radial direction from the vicinity of a predetermined center position overlapping a plane center of the slider, when the slider is mounted on the flexure.

In fact, the spacer projections are separated from one another in a diagonal direction of the slider from the vicinity of the predetermined center position.

According to another aspect of the invention, the spacer projections extend in four directions overlapping the diagonal direction of the slider from the vicinity of the predetermined center position, and spacer projections extending in two directions of the leading side and two directions of the trailing side of the slider are continuously connected, respectively, in the vicinity of the predetermined center position.

According to another aspect of the invention, the spacer projections are radially provided, from the vicinity of the predetermined center position, at the positions overlapping the diagonal line of the slider, a center line which is parallel to a longitudinal direction and passes through the plane center of the slider, and a center line which is parallel to a latitudinal direction and passes through the plane center of the slider.

According to these aspects of the invention, the slider and the respective spacer projections are adhered onto each other by an adhesive resin which is dropped, applied or filled in the vicinity of the predetermined center position and spreads out between the slider and the respective spacer projections.

According to another aspect of the invention, in a magnetic head in which a slider having a thin film magnetic element is adhesively fixed on a flexure, made of metal material, constituting a gimbal suspension through a plurality of spacer projections provided on the flexure, a plurality of spacer projections extending from a vicinity of a predetermined center position of the flexure toward edges are provided, and the respective spacer projections are formed such that the adhesive resin that is dropped, applied or filled between the slider and the respective spacer projections, and spreads along the respective spacer projections.

According to another aspect of the invention, the spacer projections which adhesively fix the slider to the flexure are provided to extend in a direction from the predetermined center position of the flexure toward edges is provided, and the slider is adhered onto the flexure by adhesive resin which is applied or filled between the slider and the spacer projections and spreads along the respective spacer projections. Therefore, the adhesive resin can be evenly applied, so that it is possible to have the whole adhesive resin uniformly exposed to ultraviolet rays when the ultraviolet rays irradiate the adhesive from the side of the slider, and to evenly cure the adhesive resin. Accordingly, the slider and flexure are kept from deforming.

### BRIEF DESCRIPTION OF THE DRAWINGS

FIG. 1 is an exploded perspective view showing an embodiment of a structure in which a slider is adhered onto a flexure to which the invention is applied;

FIG. 2 is a plan view of the flexure according to a first embodiment of the invention;

FIG. 3 is a plan view of the flexure according to a second embodiment of the invention;

FIG. 4 is a plan view of the flexure according to a third embodiment of the invention;

FIG. 5 is a plan view of the flexure according to a fourth embodiment of the invention;

FIG. 6 is a plan view of the flexure according to a fifth embodiment of the invention;

FIG. 7 is a perspective view showing an exploded state of a flexure and a slider according to the related art; and

FIG. 8 is a plan view showing a biased state of adhesive resin of a flexure according to the related art.

### DESCRIPTION OF THE PREFERRED EMBODIMENT

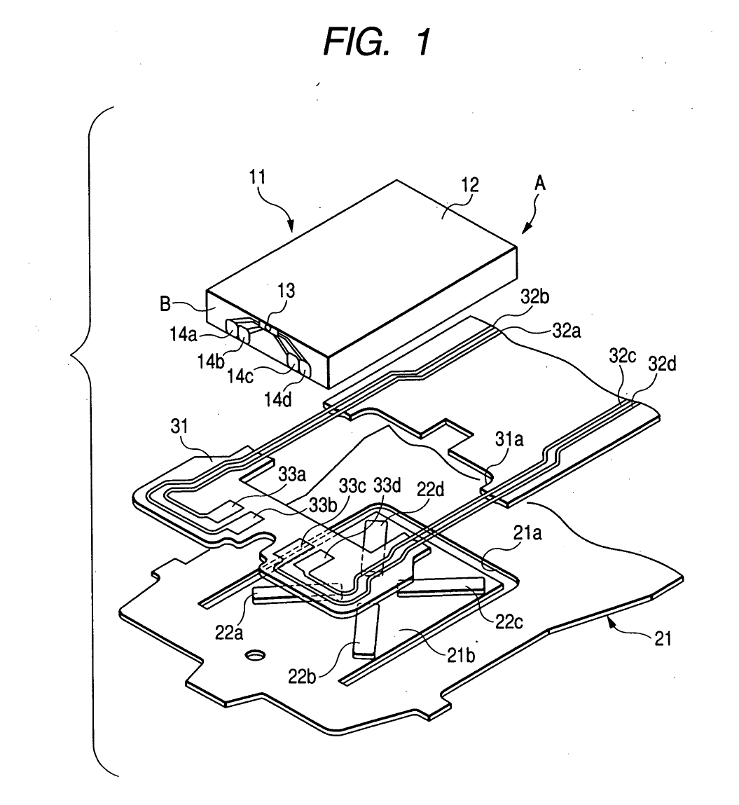

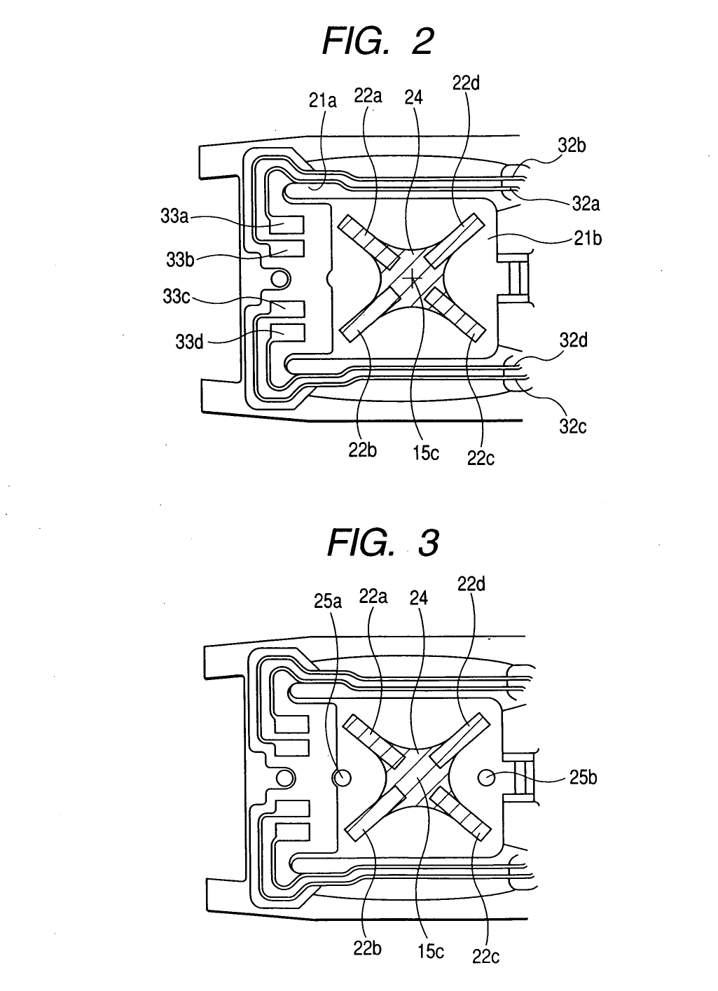

FIG. 1 is an exploded perspective view of a front tip of a flexure constituting a head gimbal assembly to which the invention is applied to, and FIG. 2 is a plan view of the flexure according to a first embodiment of the invention. A flexure 21 according to this embodiment is made of stainless steel which is laser-welded to a front tip of a load beam pivotably supported by a rotation shaft (not shown).

In the front tip of the flexure 21, a slider adhesion tongue 21b which is elastically deformable is formed by a U-shaped through groove 21a. An FPC substrate 31 is provided on the flexure 21 so as to surround the U-shaped through groove 21a. In FIG. 1, even though the FPC substrate 31 is separated from the flexure 21 for descriptive purposes, the FPC substrate 31 is formed by laminating a resin base and a lead on the flexure 21 in fact. The slider adhesion tongue 21b is exposed through an opening 31b of the FPC substrate 31.

Lead patterns 32a and 32b and lead patterns 32c and 32d are formed along edges of the opening 31a of the FPC substrate 31, that is, along the outside of both edges of the slider adhesion tongue 21b. Bonding pads 33a and 33d are formed on front tips of the lead patterns 32a and 32d. The lead patterns 32a and 32d and the bonding pads 33a and 33d are formed on the flexure 21 by laminating the resin base and the lead.

Four spacer projections 22a, 22b, 22c, and 22d are provided on the slider adhesion tongue 21b of the flexure 21 to adhesively fix the slider 11 thereon. The four spacer projections 22a to 22d are separately provided in a radial direction with respect to a plane center position 15c on which the center of the rear surface (to be contacted) of the slider 11 is superimposed, when the slider 11 is adhesively fixed. The spacer projections 22a to 22d are formed of, for example, polyimide resin, in a flat shape, and are adhered onto the slider adhesion tongue 21b. The surfaces of the bonding pads 33a to 33d are positioned at the same height (same face), and the surfaces of the spacer projections 22a to 22c are positioned at the same height as well.

The slider 11 is formed of alumina-titanium carbide, or ceramic materials, such as Si (silicon), and an air groove and an ABS surface (not shown) are formed on a surface 12 facing a recording medium. A surface opposite to the recording medium facing surface 12 of the slider 11 is a surface to contact.

A trailing end surface B of the slider 11 is provided with a film magnetic element 13, and four electrodes 14a to 14d connected to the film magnetic element 13. The film magnetic element 13 is formed by laminating permalloy (Ni—Fe alloys) of a magnetic material and alumina of an insulating material. The film magnetic element 13 includes either of a magnetic detecting part which reproduces magnetic recording signals recorded in a magnetic disk and a magnetic recording part which records magnetic signals in the magnetic disk, or both of the magnetic detecting part and the magnetic recording part. The magnetic detecting part is a GMR head formed by, for example, a giant magnetoresistance effect element (GMR element). The magnetic recording part is formed by an inductive head in which coils and cores are formed in a pattern. These magnetic recording part and magnetic detecting part are connected to the corresponding electrodes 14a to 14d. In this way, these electrodes 14a to 14d are connected to the bonding pads 33a to 33d by ball bonding with a gold ball, etc.

FIG. 2 illustrates the distribution of adhesive resin 24 on the slider adhesion tongue 21 onto which the slider 11 is adhered. In the first embodiment, a region for contact ranges from a space at the center position 15c side of the spacer projections 22a to 22d to radial ends of the spacer projections 22a to 22d.

In the first embodiment, the slider 11 is adhesively fixed on the flexure 21 as follows. The adhesive resin 24 is dropped on a region around the center position 15c, applied and filled in the region. Then, after the surface of the slider 11 for contact is pressed against the spacer projections 22a to 22d, the electrodes 14a to 14d of the slider 11 are connected the respective bonding pads 33a to 33d by ball bonding with a gold ball. As the slider 11 is pressed against the spacer projections 22a to 22d, the adhesive resin 24 evenly and radially spreads along the contacted surfaces between the spacer projections 22a to 22d and the slider 11. Then, ultraviolet radiation irradiates an interval between the slider 11 and the flexure 21 to cure the adhesive resin 24.

According to the first embodiment, the adhesive resin 24 that is dropped on the vicinity of the center position 15c, applied and filled in the vicinity evenly spreads along the spacer projections 22a to 22d in a radial direction, as the slider 11 is pressed. Moreover, when ultraviolet radiation irradiates the spread adhesive resin 24 in a direction from edges to the center position 15c, the ultraviolet radiation can evenly irradiate the adhesive resin 24, so that the adhesive resin 24 can be evenly cured. Accordingly, the slider 11 is adhesively fixed on the flexure 21 while reliably maintaining the position and direction of the slider 11. The position and direction of the slider 11 is maintained even after the adhesive resin 24 is cured.

Even though a UV hole is not provided in the first embodiment, according to a second embodiment shown in FIG. 3, a UV hole 25a may be formed in a region between the spacer projections 22a and 22b, and the trailing end surface B (bonding pads 33a to 33d) of the slider 11, and a UV hole 25b may be formed in a region between the spacer projections 22a and 22b, and a leading end surface A of the slider 11. In these regions, since the interval between the slider 11 and the flexure 21 is narrowed by the FPC 31, the UV holes 25a and 25b are provided such that ultraviolet radiation irradiates the adhesive resin 24 through these UV holes 25a and 25b, which makes it possible to more evenly cure the adhesive resin 24. More particularly, providing the UV hole 25a in a region at the trailing end surface B is available because the electrodes 14a to 14d are closely connected to the bonding pads 33a to 33d by ball bonding.

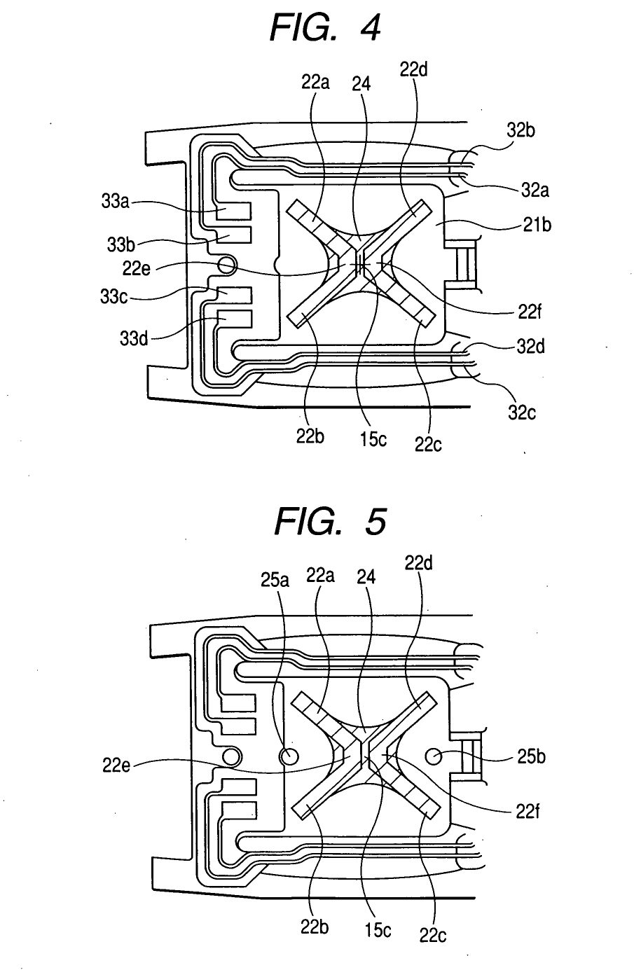

FIGS. 4 and 5 illustrate third and fourth embodiments of the invention. In the third and fourth embodiments, a spacer projection connecting part 22e connects the center position 15c side ends of the spacer projections 22a and 22b at the trailing end surface B so as to make continuous the spacer projections 22a and 22b, and a spacer projection connecting part 22f connects the center position 15c side ends of the spacer projections 22c and 22d at the leading end surface A so as to make continuous the spacer projections 22c and 22d. The spacer projection connecting parts 22e and 22f are formed at an interval so as to be extended parallel to the leading end surface A and the trailing end surface B of the slider 11.

According to the third and fourth embodiments, the adhesive resin 24, being applied and filled with respect to the interval between the spacer projections 22e to 22f, evenly spreads along the contacted surfaces of the spacer projections 22a to 22d and the slider 11 from the surface of the spacer projection connecting parts 22e and 22f.

In the fourth embodiment shown in FIG. 5, the UV hole 25a is formed in a position closer to the bonding pads 33a to 33d than the spacer projections 22a, 22e and 22b on the trailing end surface B, and the UV hole 25b is formed in a position closer to the leading end surface A than the spacer projections 22c, 22f and 22d on the leading end surface A. When ultraviolet radiation irradiates the spacer projections, since the ultraviolet radiation enters through the UV holes 25a and 25b, the adhesive resin 24 in the vicinity of the holes can be reliably cured.

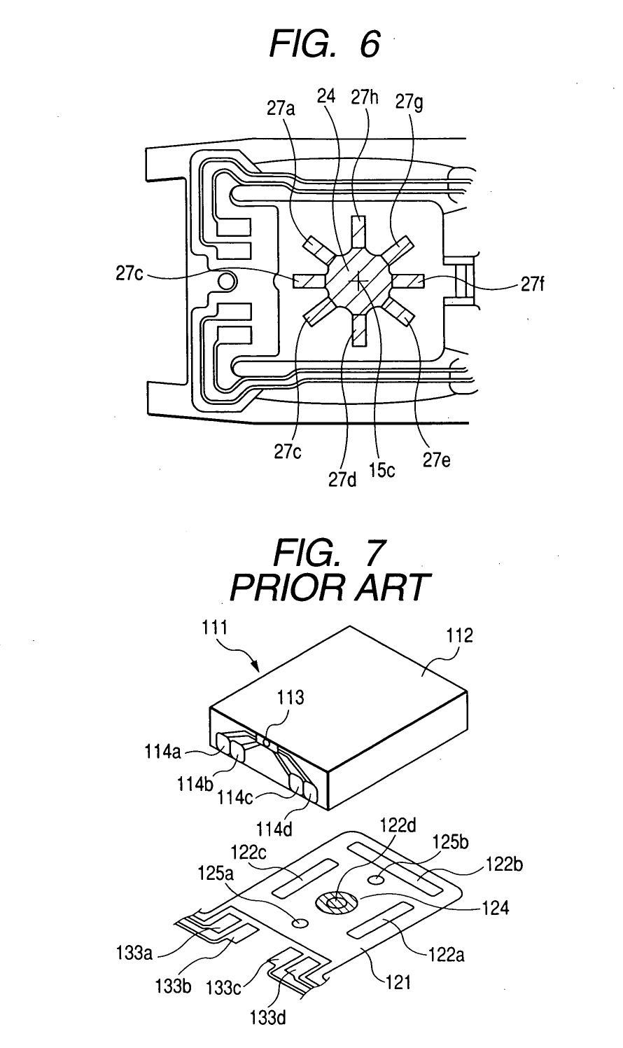

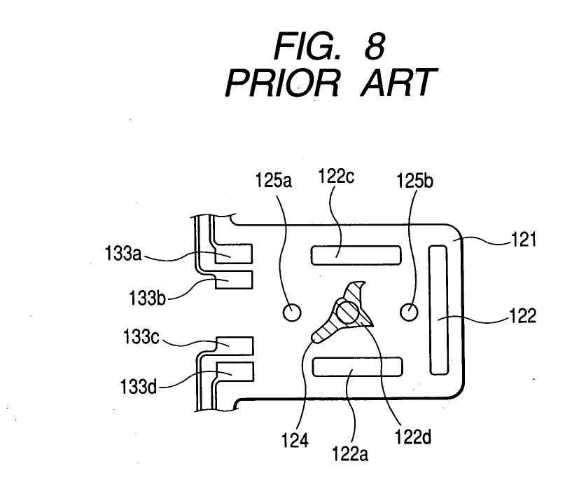

FIG. 6 illustrates a fifth embodiment. In the fifth embodiment, eight spacer projections 27a to 27h are radially provided with respect to the center position 15c. According to the fifth embodiment, the spacer projections 27a, 27c, 27e and 27g are extended in a direction overlapping a diagonal line of the surface 15 for contact of the slider 11, the spacer projections 27b and 27f are extended in a direction overlapping the center line in the longitudinal direction (passes through the center position 15c and orthogonal to the trailing end surface B and the leading end surface A) of the slider 11 that passes through the center position 15c, and the spacer projections 27d and 27h are extended in a direction overlapping the center line in the vertical direction (passes through the center position 15c and parallel to the trailing end surface B and the leading end surface A) of the slider 11 that passes through the center position 15c.

The adhesive resin 24 is applied on a central region surrounded by the center side ends of the spacer projections 27a to 27h, or center side regions of the spacer projections 27a to 27h. In this case, the adhesive resin 24 evenly spreads along the respective spacer projections 27a to 27h in a radial direction from the center. Since the length of the respective spacer projections 27a to 27h is shorter than that of the spacer projections 22a to 22d in the first embodiment, it is possible to ensure even thickness of the adhesive resin that is applied on the center side region and the outside region of the spacer projections 27a to 27h, and to allow the adhesive resin to evenly spread.

In addition, the application of the invention is not limited to the embodiments. The application of the invention may be modified such that the spacer projections 27a to 27h are radially provided at uniform intervals and angles with respect to the center. Further, even though the number of the spacer projections is 4 and 8, the number is not limited to 4 and 8.

Further, even though the number of the center position is one, it can be two or more. For example, the center position may be provided at two spots that are uniformly separated from the center position and passes through the center line in the longitudinal direction, or the center position may be provided at two spots that are uniformly separated from the center position and passes through the center line in the latitudinal direction.

1. A magnetic head in which a slider having a thin film magnetic element is adhesively fixed on a flexure by a plurality of spacer projections provided on the flexure, the flexure being made of metal material and constituting a gimbal suspension,
wherein the plurality of spacer projections extend from a vicinity of a predetermined center position of the flexure toward edges,
the slider is adhered onto the flexure by an adhesive resin which is applied or filled between the-pacer projections and spreads along the respective spacer projections.

2. The magnetic head according to claim 1,
wherein the spacer projections are provided in a radial direction from the vicinity of the predetermined center position overlapping a plane center of the slider, when the slider is mounted on the flexure.

3. The magnetic head according to claim 2,
wherein the spacer projections are separated from one another in a diagonal direction of a surface of the slider from the vicinity of the predetermined center position.

4. The magnetic head according to claim 2,
wherein the spacer projections extend in four directions overlapping the diagonal direction of the slider from the vicinity of the predetermined center position, and spacer projections extending in two directions of the leading side and two directions of the trailing side of the slider are continuously connected, respectively, in the vicinity of the predetermined center position.

5. The magnetic head according to claim 2,
wherein the spacer projections are radially provided, from the vicinity of the predetermined center position, at the positions-overlapping the diagonal line of the slider, a center line which is parallel to a longitudinal direction and passes through the plane center of the slider, and a center line which is parallel to a latitudinal direction and passes through the plane center of the slider.

6. The magnetic head according to claim 2,
wherein the plurality of spacer projections are radially provided at regular intervals from the vicinity of the predetermined center position.

7. The magnetic head according to claim 1,
wherein the slider and the respective spacer projections are adhered onto each other by an adhesive resin which is dropped, applied or filled in the vicinity of the predetermined center position and spreads out between the slider and the respective spacer projections.

8. A magnetic head in which a slider having a thin film magnetic element is adhesively fixed on a flexure, made of metal material, constituting a gimbal suspension through a plurality of spacer projections provided on the flexure,
wherein a plurality of spacer projections extending from a vicinity of a predetermined center position of the flexure toward edges are provided, and
the respective spacer projections are formed such that the adhesive resin, which is dropped, applied or filled between the slider end the respective spacer projections, spreads along the respective spacer projections.
